(19) United States
(12) Patent Application Publication
(10) Pub. No.: US 2004/0219076 A1
(43) Pub. Date: Nov. 4, 2004

(54) Catalytic converter support system

(76) Inventors: Steven A. Zettel, Cranston, RI (US); Zlatomir Kircanski, Cumberland, RI (US)

Correspondence Address: Bradley N. Ruben, PC, Suite 5A, 463 First Street, Hoboken, NJ, 07030, US

(21) Appl. No.: 10/426,330

(22) Filed: May 1, 2003

(51) Int. Cl. B01D 53/34

(52) U.S. Cl. 422/177; 422/179; 442/6

(57) ABSTRACT

A mechanical damper and support, especially suitable for supporting a catalytic converter ceramic monolith within a metal housing, is provided by two or more layers of a knitted wire mesh crimped into a bidirectional pattern such as a herringbone pattern.

### BACKGROUND OF THE INVENTION

1. Field of the Invention

This invention relates to a novel crimped wire support used for supporting and insulating a vehicle catalytic converter, and to the support structure obtained therewith.

2. The State of the Art

Knitted wire mesh is used for a wide variety of articles, from scrubbing pads to filters for the hot gases generated when airbags deploy to mechanical dampers. These meshes are made on knitting machines designed for using wire instead of thread, and so the devices have very strong needles around which the wire is wrapped as it is knitted. In the environment of a catalytic converter, high temperature resistant supports are required, such as metal wires capable of withstanding continuous exposure to temperatures in excess of 1600° F. The catalyst in the catalytic converter must be maintained at a high temperature to function efficiently.

Catalytic converters have generally been found to be effective for catalytically treating the exhaust gases of internal combustion engines. In this regard, a conventional catalytic converter generally comprises a relatively fragile ceramic monolithic onto which a catalyst, such as platinum, is deposited. This catalytic monolith resides in a metal housing having inlet and outlet ends. Within the housing the monolith is held by a supporting seal so that substantially all of the exhaust gases entering the inlet end of the housing pass through the monolithic catalyst structure and outwardly through the outlet end of the housing.

The supporting seals for catalytic converters must both cushion the catalytic monolith against breakage resulting from physical shocks as well as seal between the monolith and the housing. One of the most common materials utilized for such seals is stainless steel wire which has been formed, woven, knitted, and/or compacted into various configurations. Various patents describe aspects of various types of high temperature seals used for vehicles, including the following U.S. Pat. Nos.: 6,533,977; 6,286,840; 6,277,166; 5,385,873; 5,207,989; 4,951,954; and 4,683,010; the disclosures of which are incorporated herein by reference.

As time has progressed, government regulations on vehicle emissions, especially for automobiles, have necessitated better seals to assure catalytic conversion of the engine-exhaust gases. At the same time, automobile manufacturers have developed lower cost “canning” techniques that put additional strain on the support system. For example, the monolith is wrapped in support and put within a metal housing (the “can”), which is then spun and the ends are swaged down to seal the supported monolith within the housing. The support must recover from these forces; a conventional pleated wire mesh support does not adequately recover from the forces during this procedure.

Present wire mesh supports are poor at heat insulation, allowing heat from the catalytic conversion (an exothermic reaction) to reach the outer portions of the can relatively quickly. Wire mesh lacking an inorganic binder typically is not optimal for fluid sealing, which is why some systems utilize an intumescent mat, and the device with the mat must be heated to cause the intumescence prior to shipping to assure that the monolith is secure within the housing. In addition, serious warranty issues have been experienced as a result of mat erosion resulting from the interaction of the hot exhaust gas on the leading edge of the mat support. Once erosion starts further degradation is rapid. On the other hand, expansion of the intumescent mat due the exhaust gases and the exothermic catalytic conversion aids in securing the monolith within the can, but cooler diesel exhaust applications do not cause sufficiently rapid expansion, whereby the resulting cold hold issues have also serious warranty problems. There is also the ever present requirement for mechanically insulating the ceramic monolith (the “brick”) from jolts and shocks experienced during driving.

### SUMMARY AND OBJECTS OF THE INVENTION

In light of the foregoing, various objects of this invention include providing a catalytic converter support system having improved thermal resistance and improved recovery aspects of the support system, especially to eliminate erosion of an intumescent mat and to avoid cold hold problems.

More particularly, objects of this invention include providing a catalytic converter support system having compression characteristics that do not damage the converter during can closure, chemical and physical characteristics that will not degrade under hot gas impingement, ease of installation during assembly, thermal characteristics that insulates the outer can from the heat, effectiveness under the cooler operating conditions of diesel engines, and an acceptable cost penalty.

In summary, one aspect of this invention provides an improved wire mesh support wherein the wire mesh is crimped in a bidirectional configuration, and more preferably is crimped in a herringbone configuration.

### BRIEF DESCRIPTION OF THE FIGURES

FIG. 1 depicts a photographic comparison between an embodiment of the knitted mesh of this invention and that of the prior art.

FIG. 2 depicts a photographic perspective view of a ceramic monolith having the novel knitted mesh of this invention as a support on the outside.

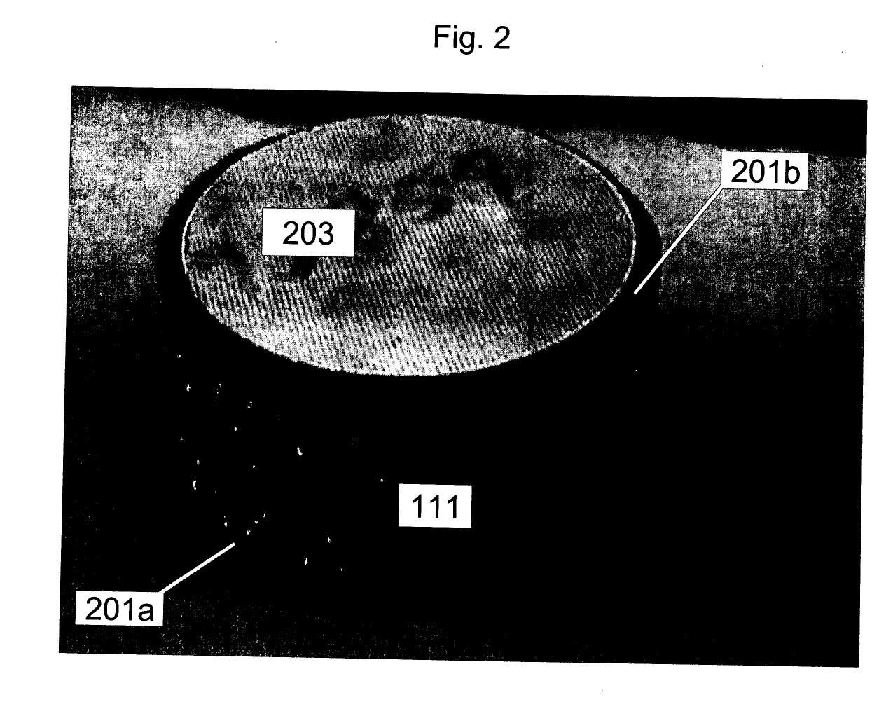

FIG. 3 depicts a graphic comparison of the recovery force during testing among a conventional mesh and two meshes made according to this invention.

### DETAILED DESCRIPTION OF SPECIFIC EMBODIMENTS

Wire knitting is a well-known art. With respect to the present invention, the base material is formed from a knitted a tube or sock of metal wire. Devices for knitting metal wire are known, and are described, for example, in U.S. Pat. Nos. 2,445,231, 2,425,293, and 4,233,825, the disclosures of which are incorporated herein by reference.

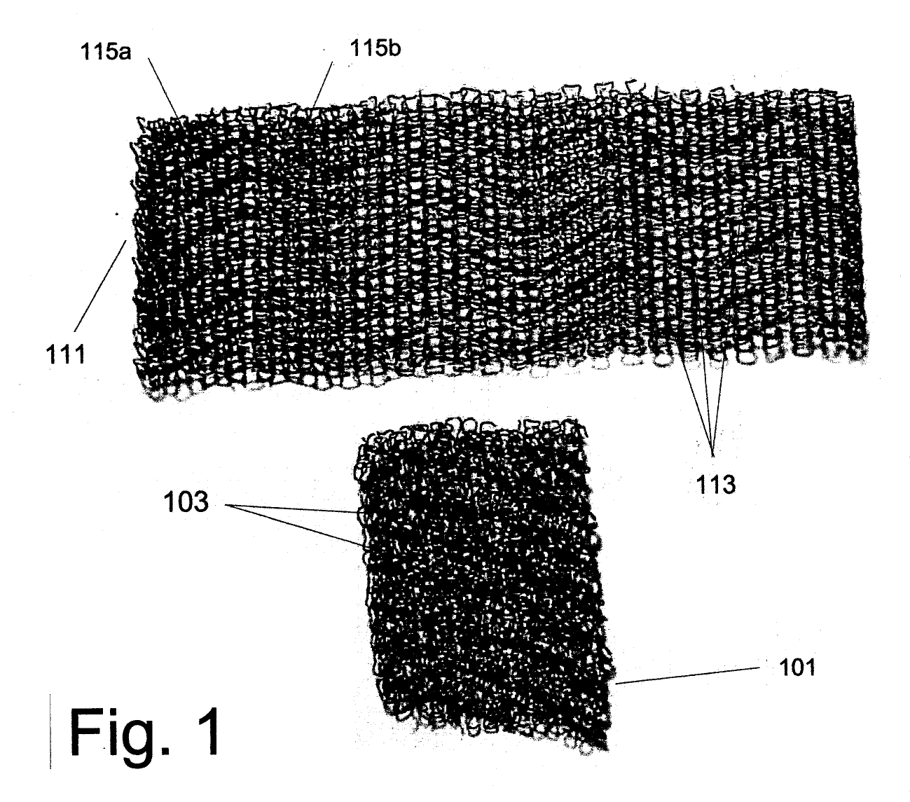

Generally, a tube of wire mesh, such as made from 0.014 inch diameter A286 wire, is knit and then crimped in a pleated pattern. As shown in FIG. 1, the convention mesh 101 (only a portion of which is shown) is cut into sheets, and the sheets are crimped into pleats 103 running parallel with each other. Crimping is typically performed by running the mesh through a patterned metal roll; in this situation, the pattern is grooves that form the pleats.

In the present invention, the mesh is crimped by a pattern that creates bidirectional pleats. Thus, also as shown in FIG. 1, the present mesh 111 is crimped into pleats 113 having a herringbone configuration. Thus, the pleat has a portion that traverses the mesh in one direction 115a and another portion that traverses the mesh in a different direction 115b, and so is “bidirectional” with respect to the convention mesh 101 having pleats that run in parallel lines.

In a preferred embodiment, two or more single layers of the wire mesh are placed adjacent each other and bidirectionally pleated to form an interlocked multilayer mesh. Optionally, the two or more layers may be crimped together at their edges prior to the crimping used to impart the desired bidirectional pattern.

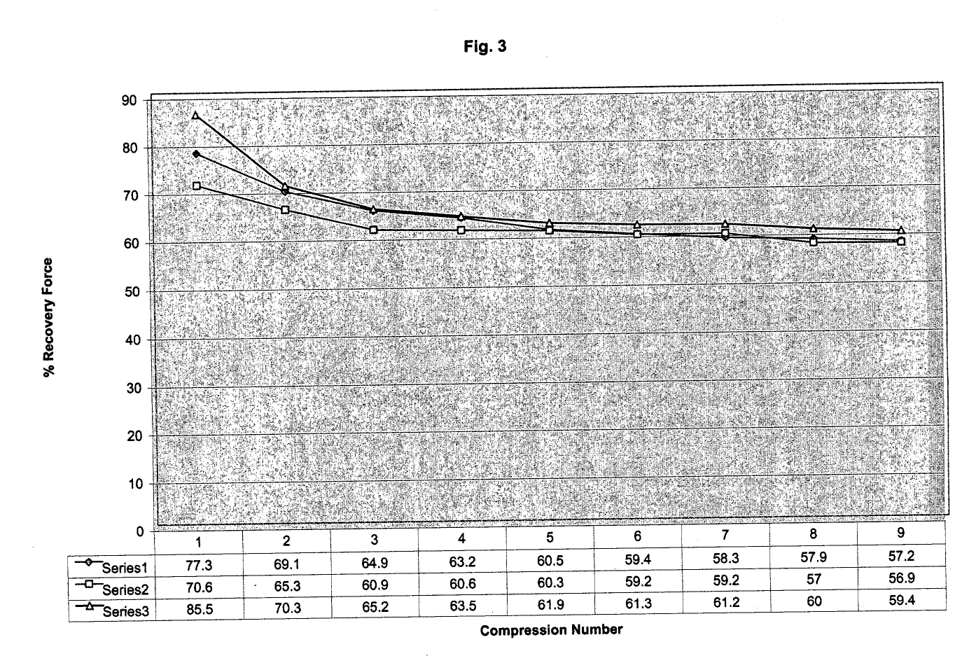

The importance of the bidirectionality can be understood better after reference is made to FIG. 3, in which the bidirectionally-pleated mesh 111 sandwiched by seals 201a and 201b surrounds a ceramic monolith 203. As shown by the arrow, the exhaust gas flow is perpendicular to the flat face of the ceramic monolith (and could just as easily be, instead, in the opposite direction). This entire cylindrical assembly of the mesh support, seals, and ceramic monolith would normally be present in a cylindrical metal housing (not shown).

When in the metal housing, the conventional support with parallel pleats provides a frictional forces better in a direction orthogonal to the parallel orientation of the pleats. Friction between the support and the housing is important for securing the assembly and cushioning the monolith against bumps and shakes as occur during normal driving. Having pleats in more than one direction, that is, at least bidirectional, provides improved friction between the support and the housing, and improved cushioning. The main function of the mesh support is to prevent the ceramic monolith from moving, because movement increases the potential for the ceramic to break. The support must also be designed so that when the monolith is sealed in the housing the recovery force (see below) of the mesh support does not fracture the monolith.

As the support has been shown in the figures as having bidirectional pleats in the configuration of a herringbone pattern, it should be understood that other bi- and multidirectional pleat configurations are also beneficial, such as a criss-crossing (or checkerboard) pattern, as well as ovals and circles, which may be overlapping (for example, having the appearance of chain links).

In practical aspects, the particular diameter of the wire and thickness of the are determined by the particular application environment. For example, the clearance between the ceramic monolith and the metal housing (the clearance between the “brick” and the “can”) will effect the diameter of the wire and the thickness of the mesh (e.g., how many layers of mesh are crimped together). Present automotive standards, for example, require a wire meeting ASTM A453/A453M-02 (for “high temperature bolting materials, with expansion coefficients comparable to austenitic stainless steels”). One suitable grade is A-286, an iron-based super alloy, preferably with a tensile range of 140 to 165 ksi and 1.5% minimum elongation.

### COMPARATIVE EXAMPLE 1

A standard A286 metal rod of 0.218″ dia. was drawn down to 0.052″, annealed at 2000° F., drawn down to 0.014″, and annealed again at 2000° F.; the annealing speed was 250 ft/min. The resulting wire had a tensile strength of 110 ksi and elongation of 37.5%.

The wire was knit into a mesh and crimped into a configuration with parallel pleats having a crimp height of 0.250″.

When the crimped mesh was compressed down to 0.220″, the mesh exerted a recovery force 34.8 psi, and when compressed down to 0.165″ the mesh exerted 82.5 psi.

This type of compression test simulates the environment between the ceramic monolith and the metal housing. The crimped mesh must allow some compression in order to fit firmly between the monolith and the housing, and it must have a recovery force (the force opposing the compression) to remain wedged between the two. However, the rebound force should not be so great as to damage the monolith.

### EXAMPLES 1A, 1B and 1C

Another A286 metal rod of 0.218″ dia. was processed as before, except that the second annealing was performed at 1600° F. and the annealing speed was 350 ft/min. The resulting wire had a tensile strength of 156 ksi and an elongation of 7.5%.

The wire was knit into a mesh and crimped into a configuration with herringbone pleats having a crimp height of 0.250″.

Using the same type of compression test as described for Comparative Example 1, when compressed to 0.220″ the crimped mesh exerted a recovery force of 43.0 psi, and 140.1 psi when compressed down to 0.165″. (Example 1A.)

The foregoing was repeated, except that the crimped mesh was heat treated at 1200° F. for three minutes. Thereafter, compression down to 0.220″ yielded a recovery force of 100.0 psi, and compression down to 0.165″ resulted in a recovery force of 422.9 psi. (Example 1B.)

The experiment above in which the mesh was heat treated was repeated, except that the mesh was heat treated for one hour instead of three minutes. When subjected to the compression testing, this mesh exhibited a recovery force of 101.6 psi at 0.220″, and a force of 445.0 psi when compressed to 0.165″. (Example 1C.)

The results of Comparative Example 1 and Examples 1A, 1B, and 1C are summarized in Table 1, following:

| | Comp. | | | |
|---|---|---|---|---|
| | Ex. 1 | Ex. 1A | Ex. 1B | Ex. 1C |
| Heat Treatment | none | none | 3 min @ 1200° | 1 hr @ 1200° |
| Crimp Type | Parallel | Herringbone | Herringbone | Herringbone |
| Crimp Height | 0.250″ | 0.250″ | 0.250″ | 0.250″ |
| Recovery at | 34.8 psi | 43.0 psi | 100.0 psi | 101.6 psi |
| 0.220″ | | | | |
| Recovery at | 82.5 psi | 140.1 psi | 422.9 psi | 445.0 psi |
| 0.165″ | | | | |

### EXAMPLES 2A, 2B, AND 2C

Herringbone crimped meshes as described above for Examples 1A, 1B, and 1C were provided for these examples, with 2A corresponding to no heat treatment, 2B corresponding to a three minute heat treatment, and 2C corresponding to a one hour heat treatment.

In this series of experiments, each mesh is subjected to a series of compressions down to 0.165″ and then allowed to recover until the recovery force equals one (1) psi. The recovery force at the maximum compression is tracked for the series of compressions.

For example: the mesh is compressed from 0.250″ to 0.165″ which requires a force of 140.1 psi (“recovery force”); the compression force is released until the force is 1 psi, at which point the mesh has recovered to a thickness of 0.215″. The mesh is again compressed to 0.165″, at which point the force required is 108.3 psi. The recovery force for the second compression is 77.3% of that required for the first compression. This series of tests is then repeated. The data and results are shown in FIG. 3; the diamonds (♦) represent the mesh without heat treatment, the squares (▪) represent heat treatment for three minutes, and the triangles (▴) represent heat treatment for one hour. Heat treating is a well-known method for hardening steel.

As described, it can be seen, that the instant mesh can be used for mechanical damping and insulation environments similar to that described.

The foregoing description is meant to be illustrative and not limiting. Various changes, modifications, and additions may become apparent to the skilled artisan upon a perusal of this specification, and such are meant to be within the scope and spirit of the invention as defined by the claims.

What is claimed is:

1. In a catalytic converter having a catalytic monolith surrounded by a wire mesh support, the improvement comprising a wire mesh support having bidirectional pleats.

2. The improved catalytic converter of claim 1, wherein the mesh has a herringbone pattern.

3. The improved catalytic converter of claim 1, wherein the mesh has been heat treated.

4. A method for making a high temperature support structure, comprising:
A. knitting a wire into a mesh; and
B. crimping the wire mesh into a bidirectional pattern.

5. The method of claim 4, further comprising the step, prior to step A., of heat treating the wire.

6. The method of claim 4, further comprising the step, subsequent to step B., of heat treating the crimped mesh.

7. The method of claim 5, further comprising the step, subsequent to step B., of heat treating the crimped mesh.

8. The method of claim 4, further comprising between steps A and B the step A′ of placing two or more layers of wire mesh in overlying relationship and crimping the two or more layers together into a bidirectional pattern.

9. The method of claim 8, wherein step A comprises knitting a wire mesh tube, and step A′ comprises flattening the tube to create two layers in overlying relationship.

10. The method of claim 4, 5, 6, 7, 8, or 9, wherein the bidirectional pattern is a herringbone pattern.
